(19) United States
(12) Patent Application Publication
(10) Pub. No.: US 2007/0046965 A1
(43) Pub. Date: Mar. 1, 2007

(54) Image processing system

(75) Inventors: Naofumi Ueda, Kyoto (JP); Syoichiro Yoshiura, Nara (JP); Yuji Okamoto, Kyoto (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/505,883

(22) Filed: Aug. 18, 2006

(30) Foreign Application Priority Data
Aug. 23, 2005 (JP) 2005-241496

(51) Int. Cl. G06K 15/02; G06F 15/00

(52) U.S. Cl. 358/1.9; 358/1.2

(57) ABSTRACT

In one embodiment, when an external view of an entire system configured from an external view of a color image processing apparatus and an external view of a monochrome image processing apparatus is displayed in a copy operation screen of a touch panel, even in the case where there is an unusable image processing apparatus, the external view of the unusable image processing apparatus is also displayed in a state in which the external view of the entire system is preserved, and at that time the external view of the usable image processing apparatus and the external view of the unusable image processing apparatus are displayed with different image forms (for example, one of the image processing apparatuses is displayed reversed).

### CROSS REFERENCE TO RELATED APPLICATIONS

This application claims priority under 35 U.S.C. § 119(a) on Patent Application No. 2005-241496 filed in Japan on Aug. 23, 2005, the entire contents of which are hereby incorporated by reference.

### BACKGROUND OF THE INVENTION

1. Field of the Invention

The present invention relates to an image processing system configured from a plurality of processing units.

2. Related Art

Recently, image processing systems (color printing apparatuses) have been proposed that continuously output printed recording paper in large quantities and quickly discharge that recording paper arranged in page order (for example, see JP H8-305221A).

In this image processing system, two printers, each of which are connected to an apparatus for feeding a multitude of sheets of paper, and a shared sorter are integrated in a stand, and each printer is provided with a control means that distributes image signals and controls the processes of each printer and the sequence of operation of the sorter. The control means outputs image signals to each printer, and alternately causes the respective printers to output recording paper according to page order, and thus discharges the recording paper arranged in page order on each bin of the sorter. That is, in the above conventional image processing system, two printers are operated at the same time in order to accelerate processing.

On the other hand, when starting up this sort of image processing system, the following two methods are conceivable. That is, a method is conceivable in which when a power button is turned on, by starting up the two printers at the same time and warming up, the two printers are placed in a usable state at the same time, and a method is conceivable in which when the power button is turned on, first one printer is started up and warmed up, and after this printer has become usable, the next printer is started up and warmup is begun.

In this case, when considering energy conservation, inrush current generated when starting up, and the like, it is preferable not to start up the two printers at the same time, but to sequentially start up the printers one at a time. When starting up the printers one at a time, after turning on power, after one printer finishes warming up and until the next printer finishes warming up, a usable printer and an unusable printer exist.

Also, in the present image processing system, in consideration of the environment there is a tendency to suppress power consumption, and also a tendency to shorten the warmup time. In order to satisfy these conditions the most attention is paid to a fixing roller. Recent fixing rollers have a smaller diameter than a generation ago, and their thickness is steadily decreasing.

As a result, for example in the above conventional image processing system, when a large amount of heavy paper has been continuously printed with one printer, there is a possibility that the temperature of the fixing roller will drop below a temperature at which fixing is possible, and in this case, it becomes necessary to temporarily interrupt print processing until recovering a temperature at which fixing is possible. That is, in the case of such circumstances as well, in one image processing system, a usable printer and an unusable printer exist.

Also, recent color image processing apparatuses have a tandem structure in which image forming units for black (BK), cyan (C), magenta (M), and yellow (Y) are disposed laterally lined up in a row, and such that the apparatus as a whole does not become large, the distance between each image forming unit becomes small, and further, the diameter of a photosensitive body of each image forming unit becomes small, and the capacity of a development unit becomes small. Thus, for example, when a large amount of originals with a large solid black portion have been consecutively printed, the amount of toner remaining in the black development unit suddenly decreases, and in addition, stable supply of the toner by agitation cannot keep up, and there is a possibility of a problem occurring in which the toner density suddenly decreases. In this case, it is necessary to temporarily interrupt print processing until toner is stably supplied by continuous agitation or the like and the toner density recovers above a standard value. That is, in such circumstances as well, for example in an image processing system in which a color image processing apparatus and a monochrome image processing apparatus are combined, a usable printer (for example, the printer of the monochrome image processing apparatus side) and an unusable printer (for example, the printer of the color image processing apparatus side) exist. In addition, during inspection or adjustment, a usable image processing apparatus and an unusable image processing apparatus exist.

In an image processing system in which two image processing apparatuses have been combined in this manner, because a usable image processing apparatus, and an unusable image processing apparatus that cannot be immediately used, are present when power is turned on and according to the status of use thereafter, it is necessary to notify the user of such circumstances in an easily understood manner.

Incidentally, recent image processing apparatuses have a configuration in which, in order to notify the user of the status of the apparatus as a whole in an easily understood manner, an operation panel displays an external view of the entire apparatus in the center portion of the operation panel, and a group of buttons is arranged around that external view (for example, see JP H11-134152A).

When a necessary location of the apparatus external view is touched, the display shifts (screen transition) to a settings screen of a mode that corresponds to the touched external view. That is, by displaying only functions necessary for the corresponding mode, and by eliminating unnecessary functions from the screen, the convenience of use for the user is improved.

When an operation panel screen like that in above JP H11-134152A is adopted as an operation panel in the above image processing system in which above-mentioned two image processing apparatuses are combined, the form of display is as follows. That is, in a state in which external views of the two image processing apparatuses are arranged lined up in the center portion of the operation panel, when one of the image processing apparatuses is in an unusable state, that image processing apparatus is removed from the screen, and only the usable image processing apparatus is displayed with an as-is external view (or an enlarged external view) in the center portion of the screen.

However, when either one of the two image processing apparatuses becomes in an unusable state as described above, due to switching the screen display of the operation panel every time according to that state such that the external view of the unusable image processing apparatus is deleted, the display form changes every time the operation panel is viewed, and so conversely, there is the problem that the user is confused.

### SUMMARY OF THE INVENTION

It is an object of the present invention to provide, in a multifunction image processing system such that a plurality of image processing apparatuses are connected, an image processing system in which by displaying the operating state of each image processing apparatus displayed on an operation panel, specifically a usable state or an unusable state, with a display form that is easy for a user to see, it is possible to clearly perceive which portion of the image processing system cannot be used.

The image processing system of the present invention, which is an image processing system configured from a plurality of processing units, is provided with a user interface (such as an operation panel) that, along with displaying system information to an operator, receives an instruction from the operator, and an interface control portion (an interface control means) that controls the display of information in the user interface and the instruction from the operator, and the interface control portion, when an external view of the entire image processing system configured from external views of the plurality of processing units is displayed via the user interface, even in the case where there is at least one unusable processing unit, also displays the external view of the unusable processing unit in a state in which the external view of the entire image processing system is preserved.

According to an image processing system with this sort of configuration, both the usable processing unit and the unusable processing unit are displayed in a state in which the external view of the entire image processing system is preserved, and so the user, with display forms that are always familiar, can clearly recognize the image processing apparatus that can be used and the image processing apparatus that cannot be used.

In this case, it is preferable that the external view of the usable processing unit and the external view of the unusable processing unit are displayed such that their display forms differ. For example, along with clearly displaying the external view of the usable processing unit, the external view of the unusable processing unit may be displayed reversed (displayed light).

Also, a configuration may be adopted in which information related to the state of the usable processing unit, and an instruction receiving interface that receives an instruction given to the processing units from the operator, are displayed on the external view of the usable processing unit, and information related to the state of the unusable processing unit is displayed on the external view of the unusable processing unit. Here, “information related to the state of the processing unit”, in the case of the usable processing unit, is information such as, for example, usable paper sizes, and by selecting a desired size from among the usable paper sizes it is possible to choose paper. On the other hand, in the case of the unusable processing unit, this sort of paper size information is also displayed reversed, and cannot be used. Also, “an instruction receiving interface that receives an instruction given to the processing units from the operator”, for example, is various selection keys for selection of a discharge destination tray, selection of whether or not to perform finishing processing, or the like, and is displayed around an external view with icons or the like.

That is, with the instruction receiving interface in the above configuration, items for the unusable processing unit are displayed reversed. That is, the display form of the instruction receiving interface (icons or the like) related to the unusable processing unit also may be changed in concert with the display form of the external view of the unusable processing unit.

The “unusable processing unit” in this case means a processing unit that is in the midst of a recovery operation to a usable state, and does not mean an unusable state that cannot be resolved unless the user directly responds somehow, such as, for example, a jam state in which recording paper is jammed.

As specific examples of unusable states of the unusable processing unit, a state in which there is a decrease in fixing temperature, a state in which there is a decrease in toner density, a state of inspection, a state of adjustment, or a state of warming up are conceivable.

### BRIEF DESCRIPTION OF THE DRAWINGS

FIG. 1 is an external configuration diagram of an image processing system that is one embodiment of the present invention.

FIG. 2 is a schematic cross-sectional view of the image processing system of the embodiment of the present invention.

FIG. 3 is a block diagram that shows the electrical configuration of the image processing system of the embodiment of the present invention.

FIG. 4 is a schematic diagram of an operation panel provided in the image processing apparatus.

FIG. 5 is a schematic diagram that shows an enlarged view of a copy operation screen of a touch panel, and shows an example display when both image processing apparatuses are in a usable state.

FIG. 6 is a schematic diagram that shows an enlarged view of the copy operation screen of the touch panel, and shows an example display when both of the image processing apparatuses are in an unusable state.

FIG. 7 is a schematic diagram that shows an enlarged view of the copy operation screen of the touch panel, and shows an example display when a monochrome image processing apparatus is in an unusable state.

FIG. 8 is a schematic diagram that shows an enlarged view of the copy operation screen of the touch panel, and shows an example display when both of the image processing apparatuses are in an unusable state.

FIG. 9 is a schematic diagram that shows an enlarged view of the copy operation screen of the touch panel, and shows an example display when a color image processing apparatus is in an unusable state.

FIG. 10 is a flowchart that shows display control processing of the copy operation screen of the touch panel when a power switch is turned on and the present image processing system is started up.

FIG. 11 is a flowchart that shows display control processing of the copy operation screen of the touch panel when the power switch is turned on and the present image processing system is started up.

FIG. 12 is a schematic diagram that shows an enlarged view of the copy operation screen of the touch panel, and shows an example display when the color image processing apparatus is in an unusable state.

FIG. 13 is a schematic diagram that shows an enlarged view of the copy operation screen of the touch panel, and shows an example display when the monochrome image processing apparatus is in an unusable state.

### DESCRIPTION OF THE PREFERRED EMBODIMENTS

Hereinafter, an embodiment of the present invention will be described with reference to the accompanying drawings.

An image processing system in the present embodiment is one type of multifunction system provided with functions such as a copy function, a printer function, a network printer function, and a network facsimile function, and two image processing apparatuses, a color image processing apparatus and a monochrome image processing apparatus, are used as image processing apparatuses.

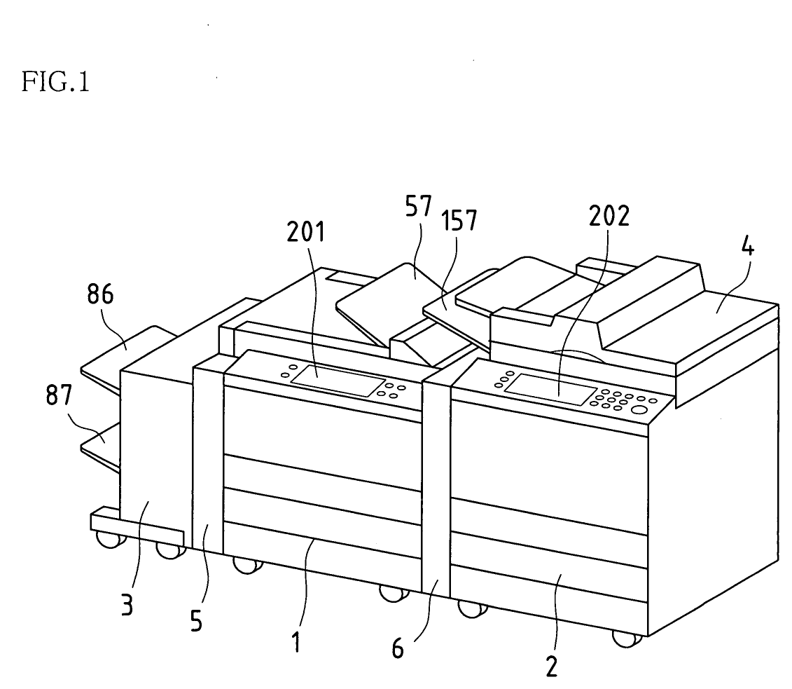

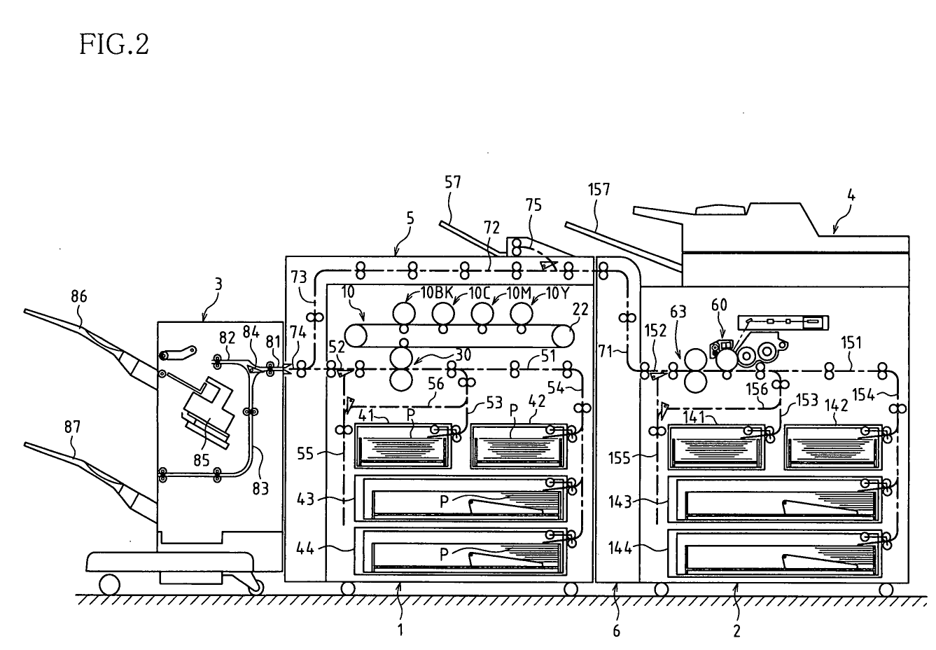

FIGS. 1 and 2 are an external view and a schematic cross-sectional view that show the arranged configuration of this sort of image processing system.

The image processing system in the present embodiment is configured with a color image processing apparatus 1 disposed in a center portion, a final processing apparatus 3 disposed on the front side (the left side in the drawings) of the color image processing apparatus 1, a monochrome image processing apparatus 2 disposed on the rear side (the right side in the drawings) of the color image processing apparatus 1, and a color image reading apparatus (a color scanner) 4 mounted on top of the monochrome image processing apparatus 2.

Also, such that the color image processing apparatus 1 is covered, a bypass transport path apparatus 5 with a reverse L shape viewed from the side is disposed from the front to the top of the color image processing apparatus 1, and between the front of the monochrome image processing apparatus 2 and the rear of the color image processing apparatus 1, a case-like transport path connecting apparatus 6 is disposed. The front of the monochrome image processing apparatus 2 is connected with the rear of the color image processing apparatus 1 via the transport path connecting apparatus 6, and the front of the color image processing apparatus 1 is connected to the rear of the final processing apparatus 3 via the bypass transport path apparatus 5.

That is, the image processing system of the present embodiment has a configuration in which, from the front to the rear, the final processing apparatus 3, the bypass transport path apparatus 5, the color image processing apparatus 1, the transport path connecting apparatus 6, and the monochrome image processing apparatus 2 are connected in series. The bypass transport path apparatus 5 is disposed on top of the color image processing apparatus 1, and the color scanner 4 is disposed on top of the monochrome image processing apparatus 2. A monochrome-side operation panel 202 is disposed on the front side of the top of the monochrome image processing apparatus 2, and a color-side operation panel 201 is disposed on the front side of the top of the color image processing apparatus 1.

Following is a simple description of the configuration of these apparatuses.

As shown in FIG. 2, the color image processing apparatus 1 is configured with four image forming units 10BK, 10C, 10M, and 10Y, an intermediate transfer unit 10, a transfer fixing unit 30, a first recording paper storage tray 41, a second recording paper storage tray 42, a third recording paper storage tray 43, a fourth recording paper storage tray 44, a horizontal feed transport path 51, a horizontal discharge transport path 52, a first vertical transport path 53, a second vertical transport path 54, a third vertical transport path 55, a horizontal return transport path 56, and a discharge storage tray 57. The discharge storage tray 57 stores monochrome image recording paper for which image processing has been performed with the monochrome image processing apparatus 2 in the rear.

As shown in FIG. 2, the monochrome image processing apparatus 2 is configured with a monochrome image forming unit 60, a fixing unit 63, a first recording paper storage tray 141, a second recording paper storage tray 142, a third recording paper storage tray 143, a fourth recording paper storage tray 144, a horizontal feed transport path 151, a horizontal discharge transport path 152, a first vertical transport path 153, a second vertical transport path 154, a third vertical transport path 155, a horizontal return transport path 156, and a discharge storage tray 157 that stores monochrome image recording paper for which image processing has been performed.

With a first extended vertical transport path 71, the transport path connecting apparatus 6 transports, in an approximately S-shaped curve, recording paper P that has been transported and discharged by the horizontal discharge transport path 152 of the monochrome image processing apparatus 2, and delivers that recording paper P to the bypass transport path apparatus 5. Thus, although omitted from FIG. 2, rollers driven by a driving means and guides are provided in the first extended vertical transport path 71.

The bypass transport path apparatus 5 transports the recording paper P that has been delivered from the first extended vertical transport path 71 of the transport path connecting apparatus 6 to the final processing apparatus 3 or the discharge storage tray 57. Also, the bypass transport path apparatus 5 transports the recording paper P that has been discharged and delivered from the horizontal discharge transport path 52 of the color image processing apparatus 1 to the final processing apparatus 3. Thus, in the bypass transport path apparatus 5, a second extended horizontal transport path 72, a third extended vertical transport path 73, a fourth extended horizontal transport path 74, and a branch transport path 75 branched from the second extended horizontal transport path 72 are provided. The rear end of the second extended horizontal transport path 72 is connected to the front end of the first extended vertical transport path 71 of the transport path connecting apparatus 6, the front end of the second extended horizontal transport path 72 is connected to the upper end of the third extended vertical transport path 73, and the lower end of the third extended vertical transport path 73 is connected to the rear end of the fourth extended horizontal transport path 74. Also, the front end of the horizontal discharge transport path 52 of the color image processing apparatus 1 is connected to the rear end of the fourth extended horizontal transport path 74. Although omitted from FIG. 2, rollers driven by a driving means and guides are provided in the second extended horizontal transport path 72, the third extended vertical transport path 73, the fourth extended horizontal transport path 74, and the branch transport path 75. Also, the top face portion of the bypass transport path apparatus 5 can be opened and closed upward, and by opening this top face portion upward, recording paper that has become jammed in the second extended horizontal transport path 72 can easily be removed.

The final processing apparatus 3 stores the recording paper P for which image processing has been performed by the color image processing apparatus 1 or the monochrome image processing apparatus 2. The final processing apparatus 3 is provided with a function whereby when storing this recording paper P, a plurality of pages of the recording paper P that have been transported are stored in order, and the plurality of pages of the recording paper P that are stored are bound. Thus, in the final processing apparatus 3, a first storage horizontal transport path 81, a second storage horizontal transport path 82, a third storage transport path 83, a transport path switching lever 84, a finisher 85, a first storage tray 86, and a second storage tray 87 are provided. Of these, the first storage horizontal transport path 81, the second storage horizontal transport path 82, and the third storage transport path 83 are used to transport the recording paper P that has been received from the fourth extended horizontal transport path 74 of the bypass transport path apparatus 5 to the finisher 85 or the second storage tray 87. The rear end of the first storage horizontal transport path 81 is connected to the front end of the fourth extended horizontal transport path 74 of the bypass transport path apparatus 5, and the front end of the first storage horizontal transport path 81 is connected to the rear end of the second storage horizontal transport path 82 and the upper end of the third storage transport path 83. The transport path switching lever 84 is provided in this connected portion, and by this transport path switching lever 84, the recording paper P that has been transported by the first storage horizontal transport path 81 having a short transport distance, is switched to either the second storage horizontal transport path 82 or the third storage transport path 83. Although omitted from FIG. 2, rollers driven by a driving means and guides are provided in the above first storage horizontal transport path 81, the second storage horizontal transport path 82, and the third storage transport path 83.

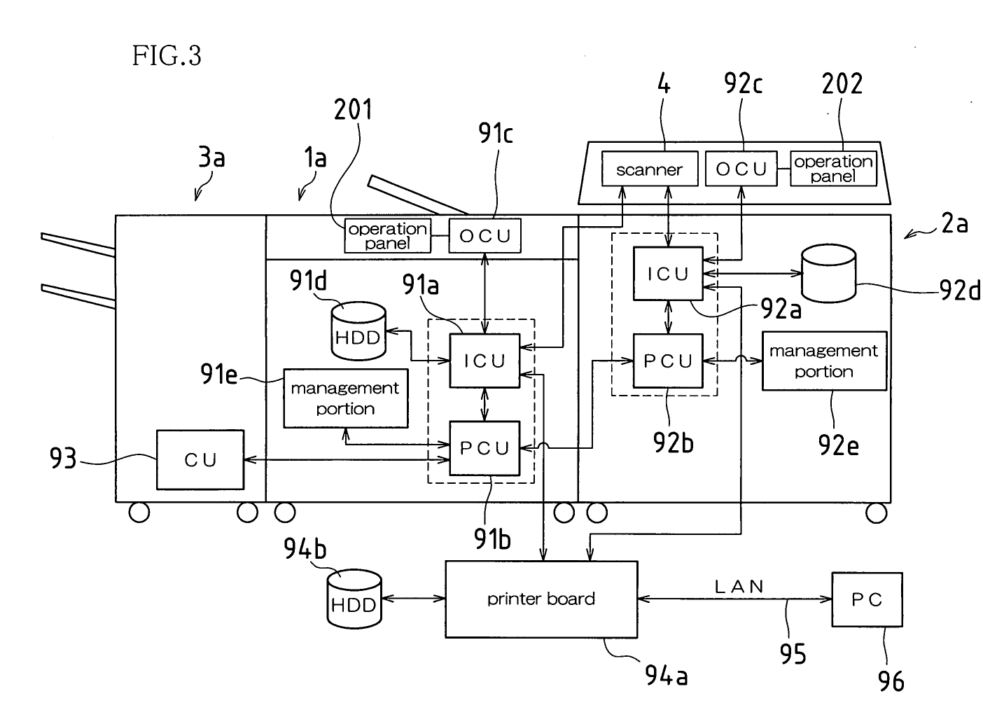

FIG. 3 is a block diagram that shows the electrical configuration of the image processing system with the above configuration. As described above, this image processing system is configured with the color image processing apparatus 1, the monochrome image processing apparatus 2 with the color scanner 4 mounted on top, and the final processing apparatus 3, and basically, a control portion is provided in the respective apparatuses such that each of these apparatuses can be used independently.

That is, the color image processing apparatus 1, the monochrome image processing apparatus 2, and the final processing apparatus 3 are respectively provided with a color-side control portion 1a, a monochrome-side control portion 2a, and a final-processing-side control portion 3a. Of these, a control function for the bypass transport path apparatus 5 is included in the color-side control portion 1a, and control functions for the color scanner 4 and the transport path connecting apparatus 6 are included in the monochrome-side control portion 2a. In addition, a control function necessary for the image processing system in the present embodiment is included in the color-side control portion 1a.

The color-side control portion 1a is configured with a color-side ICU (image control unit) 91a, a color-side PCU (print control unit) 91b, a color-side OCU (operator control unit) 91c having the color-side operation panel 201, a color-side HDD 91d, and a color-side management portion 91e. The color-side ICU 91a performs processing related to color image data that is processed with the color image processing apparatus 1. When the color image processing apparatus 1 is independently used alone, and when a color scanner or the like is also mounted on top of the color image processing apparatus 1, the color-side ICU 91a also performs control related to this color scanner. The color-side HDD 91d temporarily stores image data read from the color scanner 4. The color-side PCU 91b performs control of the color image processing apparatus 1 described above. The color-side OCU 91c is a portion operated by the user (the operator) who performs operation of the color image processing apparatus 1, and is provided with the color-side operation panel 201 in which a touch panel is disposed on a liquid crystal display. The color-side management portion 91e is a memory that stores management information for managing the processing performed by the color image processing apparatus 1. The color-side PCU 91b refers to the management information stored by the color-side management portion 91e, and performs control of the color image processing apparatus 1 based on the information to which the color-side PCU 91b referred.

The monochrome-side control portion 2a is configured with a monochrome-side ICU 92a, a monochrome-side PCU (print control unit) 92b, a monochrome-side OCU (operator control unit) 92c having the monochrome-side operation panel 202, a monochrome-side HDD 92d, and a monochrome-side management portion 92e. The monochrome-side ICU 92a, basically, performs processing related to monochrome image data that is processed with the monochrome image processing apparatus 2, but as in this system, when the color scanner 4 is mounted on the monochrome image processing apparatus 2, the monochrome-side ICU 92a also performs control related to the color scanner 4, including processing of color image data that is read with the color scanner 4. The monochrome-side HDD 92d temporarily stores the above image data. The monochrome-side PCU 92b performs control of the monochrome image processing apparatus 2 described above. The monochrome-side OCU 92c is a portion operated by the operator who performs operation of the monochrome image processing apparatus 2, and is provided with the monochrome-side operation panel 202 in which a touch panel is disposed on a liquid crystal display. The monochrome-side management portion 92e is a memory that stores management information for managing the processing performed by the monochrome image processing apparatus 2. The monochrome-side PCU 92b refers to the management information stored by the monochrome-side management portion 92e, and performs control of the monochrome image processing apparatus 2 based on the information to which the monochrome-side PCU 92b referred.

The final-processing-side control portion 3a is configured with a CU (control unit) 93. The CU 93 performs control of the final processing apparatus 3. In the final-processing-side control portion 3a, an OCU (operator control unit) is not provided, and information from the color-side OCU 91c of the color-side control portion 1a or the monochrome-side OCU 92c of the monochrome-side control portion 2a is used as information related to operating instructions for the final processing apparatus 3.

With respect to control of the image processing system of the present embodiment, other than the above, a printer board 94a and an HDD 94b are provided, and the printer board 94a is connected to the color-side ICU 91a and the monochrome-side ICU 92a. The printer board 94a is connected to a LAN 95 that is installed external to this image processing system, and via the LAN 95, the printer board 94a is connected to a personal computer (PC) 96 connected to the LAN. The printer board 94a receives image data transmitted from the personal computer 96 to this image processing system via the LAN 95, and transmits the image data to the color-side ICU 91a or the monochrome-side ICU 92a. The HDD 94b temporarily stores this image data.

Also, in the control of this image processing system, the color-side PCU 91b that performs control of the color image processing apparatus 1 and the monochrome-side PCU 92b that performs control of the monochrome image processing apparatus 2 are connected to each other, and they can exchange necessary information. Also, the color scanner 4 is connected to both the monochrome-side ICU 92a and the color-side ICU 91a, and all of the image data read with the color scanner 4 is stored in the color-side HDD 91d. Also, with this system, a function that unifies the entire system is given to the color-side PCU 91b. Thus, the color-side PCU 91b, such that this system can most effectively perform processing, gives instructions to the monochrome-side PCU 92b and the CU 93 of the final-processing-side control portion 3a.

The above color-side OCU 91c and the above monochrome-side OCU 92c each independently exist such that the color-side OCU 91c, essentially, only gives instructions to the color image processing apparatus 1, and likewise the monochrome-side OCU 92c, essentially, only gives instructions to the monochrome image processing apparatus 2. For example, information such as the type of recording paper P that is stored in the color image processing apparatus 1 and the monochrome image processing apparatus 2, and the recording paper storage tray in which that recording paper P has been stored, is respectively independently input from the color-side OCU 91c and the monochrome-side OCU 92c.

However, in the control of this image processing system, in order to increase the efficiency of the system, the color-side OCU 91c and the monochrome-side OCU 92c have different roles from each other. That is, the monochrome-side operation panel 202 of the monochrome image processing apparatus 2 on which the color scanner 4 is mounted performs input of image data related to the color scanner 4, the monochrome image processing apparatus 2, the color image processing apparatus 1, and the final processing apparatus 3, and gives processing instructions or the like. On the other hand, the operating status of the monochrome image processing apparatus 2 and the color image processing apparatus 1, conformation of image data whose input is finished, processing instructions, and the like are displayed on the color-side operation panel 201 of the color image processing apparatus 1.

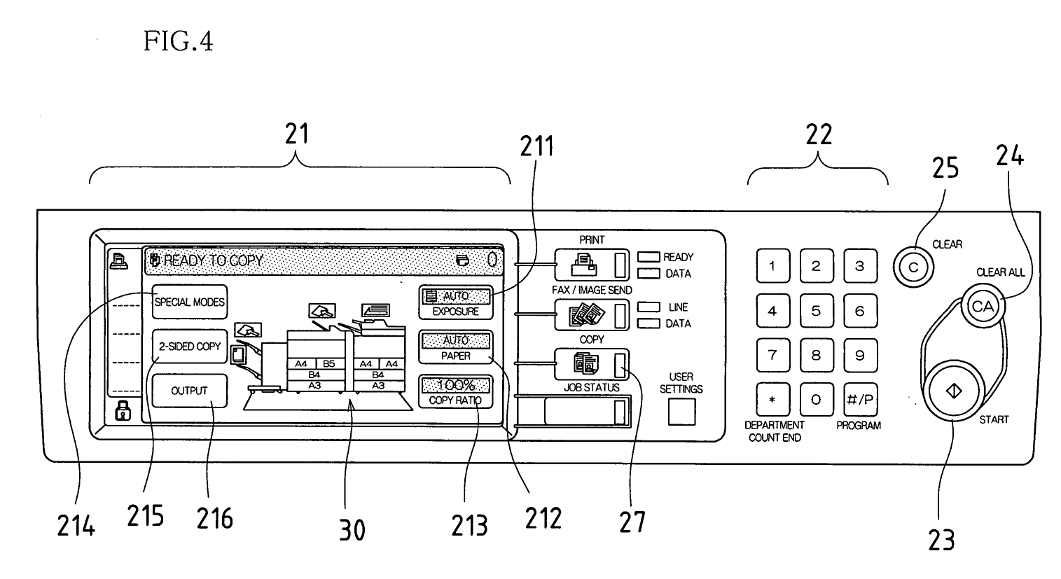

FIG. 4 is a schematic diagram that shows the configuration of the monochrome-side operation panel 202. Because the configuration of the color-side operation panel 201 is basically the same as the configuration of the monochrome-side operation panel 202 shown in FIG. 4, here a detailed description of the color-side operation panel 201 is omitted.

The monochrome-side operation panel 202 is provided with a touch panel 21 that displays necessary information and receives various instructions from the user, numeric keys 22, a start key 23 that receives a processing start instruction from the user, a clear all key 24, and a clear key 25.

The monochrome-side operation panel 202 is also provided with a print key that receives a printer instruction, a fax/image send key that receives an instruction to send the image data outside via the printer board 94a, a copy key 27 that receives a copy instruction, and a job status key that receives an instruction to display information that expresses the processing status of the image data.

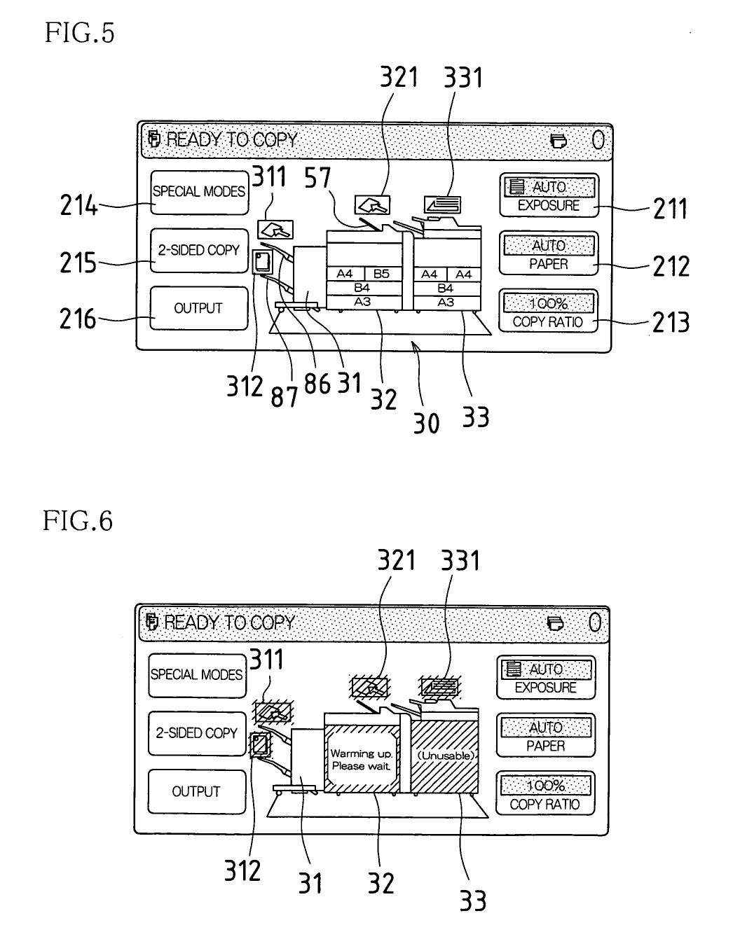

The display screen of the touch panel 21 displayed in FIG. 4 is a copy operation screen, and this operation screen is displayed when the user has operated the copy key 27. Also, FIG. 5 is a schematic diagram that shows an enlarged view of the copy operation screen of the touch panel 21.

In the center portion of the copy operation screen, an external view 30 of this entire system is displayed. That is, from the left side of the screen, an external view 31 of the final processing apparatus 3 (hereinafter, referred to as the “final processing external view”), an external view 32 of the color image processing apparatus 1 (hereinafter, referred to as the “color external view”), and an external view 33 of the monochrome image processing apparatus 2 (hereinafter, referred to as the “monochrome external view”) are displayed in order. Also, a discharge destination icon 311 for selecting a discharge destination is displayed at the position of the final processing external view 31 that corresponds to the first storage tray 86 of the final processing apparatus 3, and a staple icon 312 for selecting staple processing is displayed at the position of the final processing external view 31 that corresponds to the second storage tray 87 of the final processing apparatus 3. Inside the color external view 32, selectable paper sizes and their storage positions are displayed, and a discharge destination icon 321 for selecting a discharge destination is displayed at the position above the color external view 32 that corresponds to the discharge storage tray 57, which stores the recording paper on which a monochrome image has been printed. Also, inside the monochrome external view 33, selectable paper sizes and their storage positions are displayed, and above that an original set icon 331 that indicates that an original is set in the color scanner 4 is displayed. The original set icon 331 is displayed only when an original has been set in the color scanner 4. The display state shown in FIG. 5 is the display state when both the color image processing apparatus 1 and the monochrome image processing apparatus 2 are in a usable state, and the external views 31 to 33 and the icons 311, 312, and 321 are all clearly (i.e., as a usable state) displayed.

On the right side of the external view 30, a exposure key 211 that receives designation of the copy density, a paper key 212 that receives designation of the recording paper on which the copied image will be recorded, and a copy ratio key 213 that receives designation of the copy ratio are displayed. The respective keys display the content designated by the user's operation in the top half of the keys. Also, on the left side of the external view 30, a special modes key 214 that receives designation of settings for special processing conditions such as division of a copied image or joining of a plurality of images, a 2-sided copy key 215 that receives designation of a 2-sided copy condition, and an output key 216 that receives designation of finishing processing such as staple fastening or folding.

In the above configuration, with this embodiment, the color-side PCU 91b is the main body and works in connection with the monochrome-side PCU 92b, and after respectively confirming whether the color image processing apparatus 1 and the monochrome image processing apparatus 2 are in a usable state or an unusable state, that state is displayed in the copy operation screen of the touch panel 21 in a display form according to that state.

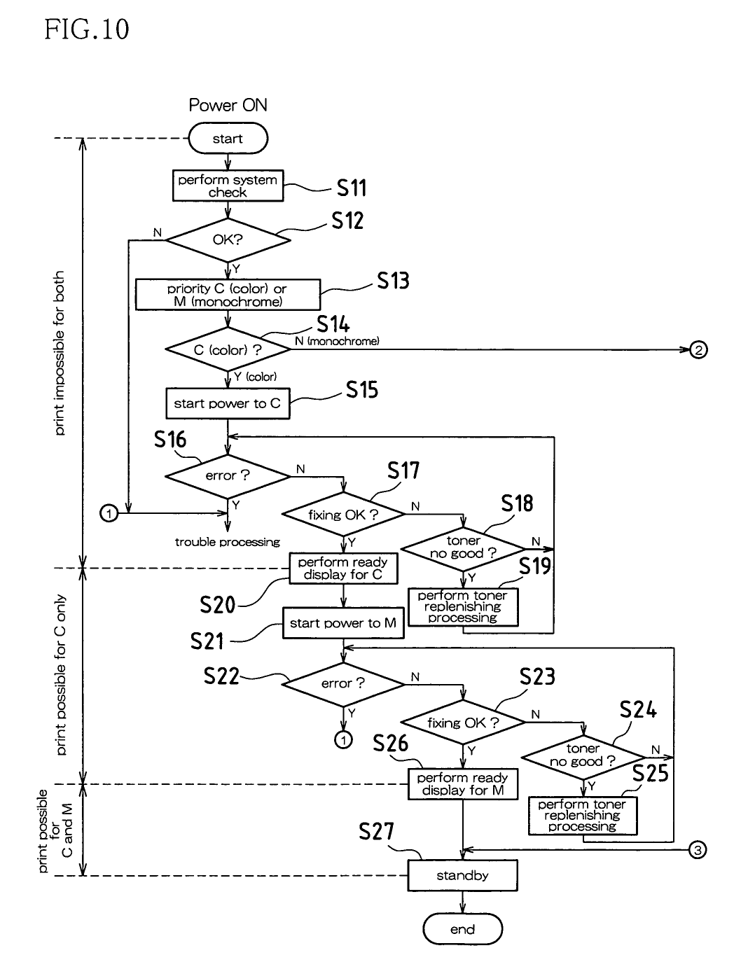

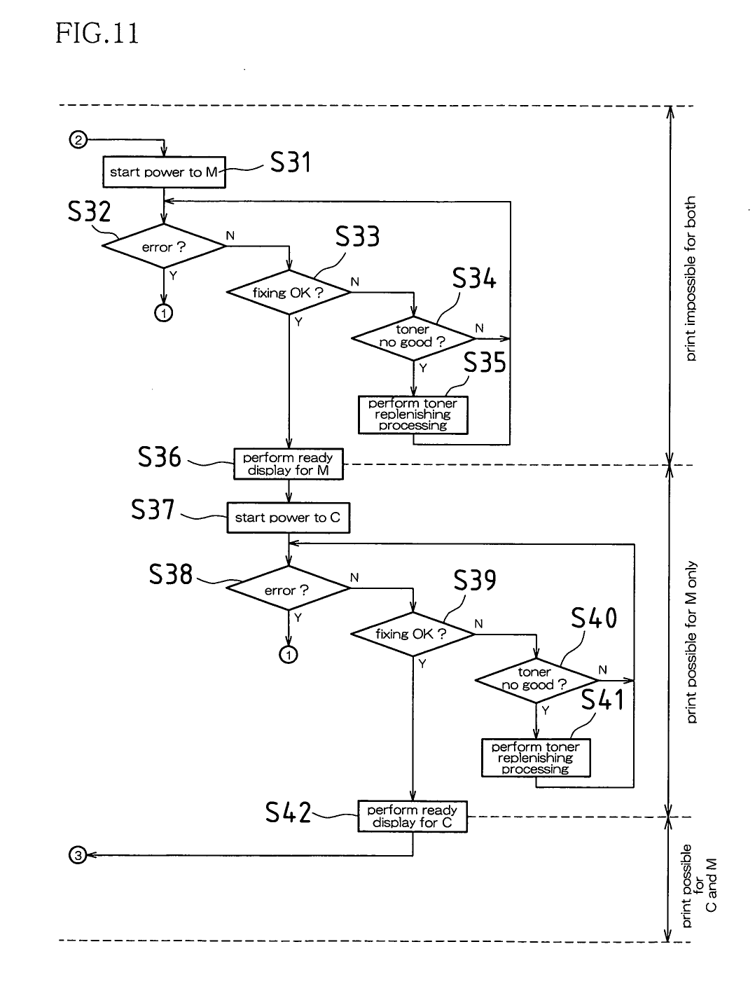

Following is a description of display control processing for the copy operation screen of the touch panel 21 when an unshown power switch is turned on and this image processing system is started up, with reference to the schematic diagrams of example operation screens shown in FIGS. 5 to 9 and the flowcharts of display control processing shown in FIGS. 10 and 11. However, with the image processing system of this embodiment, in consideration of energy conservation, inrush current generated when starting up, and the like, when power is turned on both of the image processing apparatuses 1 and 2 are not started up and warmup begun at the same time, but rather this image processing system is set such that beginning with either one of the image processing apparatuses, they are started up in order according to an order that has been set in advance. In the flowcharts in FIGS. 10 and 11, the processing of the color image processing apparatus 1 is abbreviated as “C”, and the processing of the monochrome image processing apparatus 2 is abbreviated as “M”.

When power for this image processing system is turned on, the color-side PCU 91b, working in connection with the monochrome-side PCU 92b, performs a check of the entire system (Step S11), and if there are no problems (if judged Yes in Step S12), next, according to a priority sequence that is internally set in advance, determines the image processing apparatus of the side that initially starts to warm up (Steps S13 and S14). Here, when internal settings have been set such that the color image processing apparatus 1 is given priority (when it has been judged Yes in Step S14), first power is started to the color image processing apparatus 1, and warmup is started. (Step S15).

FIG. 6 shows the display state of the copy operation screen at this time. That is, both the color external view 32 and the monochrome external view 33 are displayed in reverse in a state preserving those external views (reverse display is shown in FIG. 6 with diagonal lines, same below). Also, all of the icons 311, 312, 321, and 331 are shown displayed in reverse (reverse display is shown in FIG. 6 with diagonal lines, same below.). Also, at this time, a message indicating that the color image processing apparatus 1 is warming up (for example, “Warming up. Please wait.” or the like) is displayed in the color external view 32, and a message that simply states “Unusable” is displayed in the monochrome external view 33. Thus, the user can confirm that although the color image processing apparatus 1 cannot presently be used, it will soon be in a usable state.

In this sort of display state, the color-side PCU 91b, while continuously performing a system error check (Step S16), continues warmup of the color image processing apparatus 1, and checks whether or not the temperature of the fixing roller (the fixing temperature) has increased to a temperature at which fixing is possible (Step S17). At this time the color-side PCU 91b also checks the toner density (Step S18), and when the toner density is reduced (when judged Yes in Step S18), the color-side PCU 91b performs toner replenishing processing (Step S19).

Then, when the result of this sort of fixing temperature check and toner density check is that it was judged that the fixing temperature has increased to a temperature at which fixing is possible (when judged Yes in Step S17), warmup of the color image processing apparatus 1 is finished (Step S20), and along with moving the color image processing apparatus 1 to a usable standby state, power to the monochrome image processing apparatus 2 is started from this point in time, and warmup of the monochrome image processing apparatus 2 is started (Step S21).

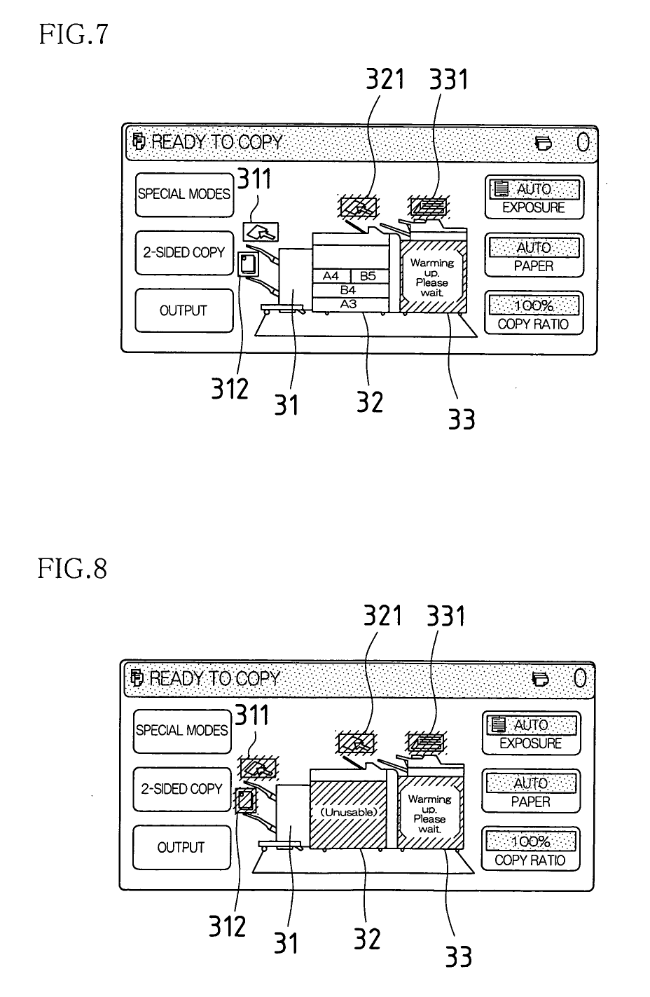

FIG. 7 shows the display state of the copy operation screen at this time. That is, while the color external view 32 changes from reversed display to clear display (usable display), the monochrome external view 33 continues to be displayed in reverse in a state preserving that external view. The icons 311 and 312 related to operation of the color image processing apparatus 1 also change from reversed display to clear display (usable display), but the icon 321 is for selecting the discharge storage tray 57 that stores the recording paper that has been printed with the monochrome image processing apparatus 2, so this icon 321 remains displayed reversed. The original set icon 331 is usable from this point in time, but because it changes from reversed display to clear display when an original has been set in the color scanner 4, the original set icon 331 is still displayed reversed at this point in time. Also, at this time a message indicating that the monochrome image processing apparatus 2 is warming up (for example, “Warming up. Please wait.” or the like) is displayed in the monochrome external view 33. Thus, the user can confirm that the color image processing apparatus 1 is usable, and although the monochrome image processing apparatus 2 cannot presently be used, it too will soon be in a usable state.

In this sort of display state, the monochrome-side PCU 92b, while continuously performing a system error check (Step S22), continues warmup of the monochrome image processing apparatus 2, and checks whether or not the temperature of the fixing roller (the fixing temperature) has increased to a temperature at which fixing is possible (Step S23). At this time the monochrome-side PCU 92b also checks the toner density (Step S24), and when the toner density is reduced (when judged Yes in Step S24), the monochrome-side PCU 92b performs toner replenishing processing (Step S25).

Then, when the result of this sort of fixing temperature check and toner density check is that it was judged that the fixing temperature has increased to a temperature at which fixing is possible (when judged Yes in Step S23), warmup of the monochrome image processing apparatus 2 is finished (Step S26), and the monochrome image processing apparatus 2 is moved to a usable standby state (Step S27).

FIG. 5 shows the display state of the copy operation screen at this time. That is, the color image processing apparatus 1, the monochrome image processing apparatus 2, and the icons 311, 312, and 321 all change to clear display (usable display). Thus, the user can confirm that all of the functions of the color image processing apparatus 1 and the monochrome image processing apparatus 2 are usable.

The above processing is the processing in the case that when power is turned on priority is given to starting up the color image processing apparatus 1, but when the internal settings have been set so that the monochrome image processing apparatus 2 is started up first, the judgment in Step S14 is No, and the operation advances to Step S31. That is, first power is started to the monochrome image processing apparatus 2, and warmup is started.

FIG. 8 shows the display state of the copy operation screen at this time. That is, both the color external view 32 and the monochrome external view 33 are displayed reversed in a state preserving those external views. Also, the icons 311, 312, 321 and 331 are all displayed reversed. Also, at this time, a message indicating that the monochrome image processing apparatus 2 is warming up (for example, “Warming up. Please wait.” or the like) is displayed in the monochrome external view 33, and a message that simply states “Unusable” is displayed in the color external view 32. Thus, the user can confirm that although the monochrome image processing apparatus 2 cannot presently be used, it will soon be in a usable state.

In this sort of display state, the monochrome-side PCU 92b, while continuously performing a system error check (Step S32), continues warmup of the monochrome image processing apparatus 2, and checks whether or not the temperature of the fixing roller (the fixing temperature) has increased to a temperature at which fixing is possible (Step S33). At this time the monochrome-side PCU 92b also checks the toner density (Step S34), and when the toner density is reduced (when judged Yes in Step S34), the monochrome-side PCU 92b performs toner replenishing processing (Step S35).

Then, when the result of this sort of fixing temperature check and toner density check is that it was judged that the fixing temperature has increased to a temperature at which fixing is possible (when judged Yes in Step S33), warmup of the monochrome image processing apparatus 2 is finished, and along with moving the monochrome image processing apparatus 2 to a usable standby state (Step S36), power to the color image processing apparatus 1 is started from this point in time, and warmup of the color image processing apparatus 1 is started (Step S37).

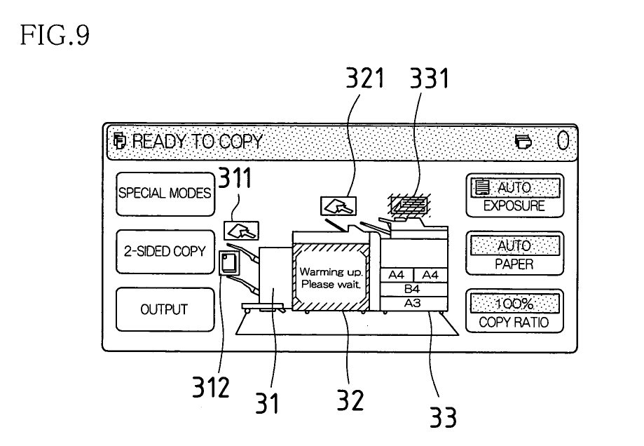

FIG. 9 shows the display state of the copy operation screen at this time. That is, while the monochrome external view 33 changes from reversed display to clear display (usable display), the color external view 32 continues to be displayed in reverse in a state preserving that external view. The icons 311, 312, and 321 related to operation of the monochrome image processing apparatus 2 also change from reversed display to clear display (usable display). Also, at this time a message indicating that the color image processing apparatus 1 is warming up (for example, “Warming up. Please wait.” or the like) is displayed in the color external view 32. Thus, the user can confirm that the monochrome image processing apparatus 2 is usable, and although the color image processing apparatus 1 cannot presently be used, it too will soon be in a usable state.

In this sort of display state, the color-side PCU 91b, while continuously performing a system error check (Step S38), continues warmup of the color image processing apparatus 1, and checks whether or not the temperature of the fixing roller (the fixing temperature) has increased to a temperature at which fixing is possible (Step S39). At this time the color-side PCU 91b also checks the toner density (Step S40), and when the toner density is reduced (when judged Yes in Step S40), the color-side PCU 91b performs toner replenishing processing (Step S41).

Then, when the result of this sort of fixing temperature check and toner density check is that it was judged that the fixing temperature has increased to a temperature at which fixing is possible (when judged Yes in Step S39), warmup of the color image processing apparatus 1 is finished (Step S42), and the color image processing apparatus 1 is moved to a usable standby state.

FIG. 5 shows the display state of the copy operation screen at this time. That is, the color image processing apparatus 1, the monochrome image processing apparatus 2, and the icons 311, 312, and 321 all change to clear display (usable display). Thus, the user can confirm that all of the functions of the color image processing apparatus 1 and the monochrome image processing apparatus 2 are usable.

The above is the display control processing of the copy operation screen of the touch panel 21 when the power switch is turned on and this image processing system is started up.

This sort of case in which one of the image processing apparatuses 1 and 2 is in a usable state and the other is in an unusable state is not limited to when the power is turned on. For example, when a large amount of heavy paper has been continuously printed by the color image processing apparatus 1, as described in the above “BACKGROUND OF THE INVENTION”, there is a possibility that the temperature of the fixing roller will drop below a temperature at which fixing is possible. In this case, it becomes necessary to temporarily interrupt the print operation until the fixing roller recovers to a temperature at which fixing is possible, and during this time the color image processing apparatus 1 temporarily becomes unusable.

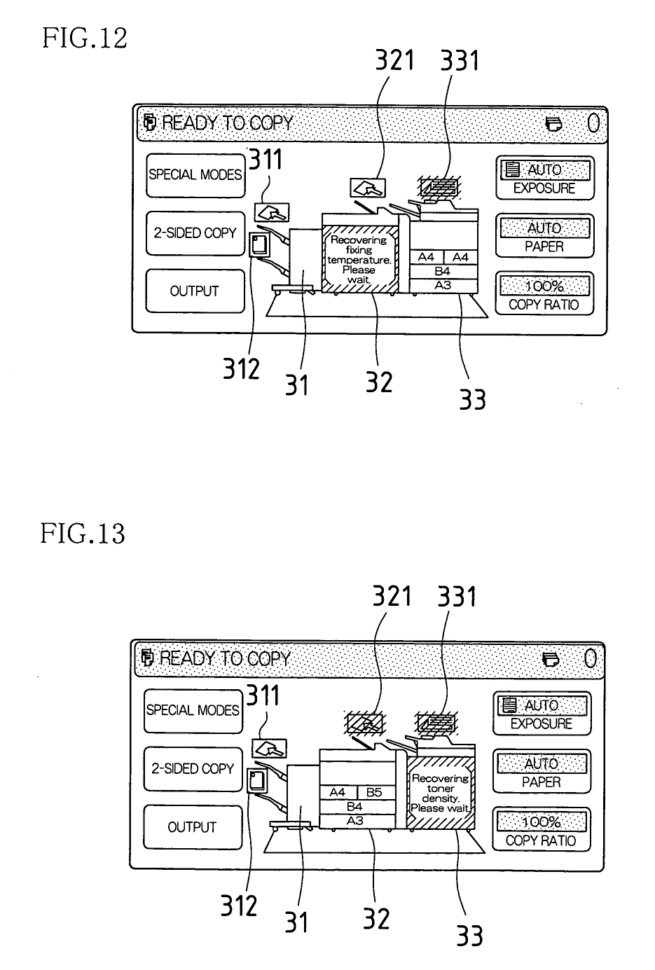

FIG. 12 shows the display state of the copy operation screen at this time. That is, the color external view 32 is displayed reversed in a state preserving that external view. Also, because the monochrome image processing apparatus 2 is in a usable state, the monochrome external view 33 and the icons 311, 312, and 321 are all displayed clear (usable display). Also, at this time, a message indicating that the color image processing apparatus 1 is in the midst of a fixing temperature recovery operation (for example, “Recovering fixing temperature. Please wait.” or the like) is displayed in the color external view 32. Thus, the user can confirm that although the print operation is presently interrupted, soon the color image processing apparatus 1 will be in a usable state, and the print operation will start again.

Also, for example, in a case such as when a large amount of originals with a large solid black portion have been consecutively printed, the amount of toner remaining in the black development unit suddenly decreases, and in addition, stable supply of the toner by agitation cannot keep up, and there is a possibility that the toner density will suddenly decrease. In this case, it is necessary to temporarily interrupt print processing until toner is stably supplied by continuous agitation or the like and the toner density recovers above a standard value. During this time, the monochrome image processing apparatus 2 temporarily becomes unusable.

FIG. 13 shows the display state of the copy operation screen at this time. That is, the monochrome external view 33 is displayed reversed in a state preserving that external view. Also, because the color image processing apparatus 1 is in a usable state, the color external view 32 and the icons 311 and 312 are displayed clear (usable display). Also, at this time, a message indicating that the monochrome image processing apparatus 2 is in the midst of a toner density recovery operation (for example, “Recovering toner density. Please wait.” or the like) is displayed in the monochrome external view 33. Thus, the user can confirm that although the print operation is presently interrupted, soon the monochrome image processing apparatus 2 will be in a usable state, and the print operation will start again.

Other than the above decrease in the fixing temperature and decrease in toner density, also during apparatus inspection or adjustment, a usable image processing apparatus and an unusable image processing apparatus exist, so in this case as well, same as described in the above embodiment, it is possible to display the usable image processing apparatus and the unusable image processing apparatus in the copy operation screen with different display forms, in a state in which the external views are preserved.

According to the image processing system of the present invention, a configuration was adopted in which in a user interface of the touch panel 21 or the like, both the usable image processing apparatus and the unusable image processing apparatus are displayed with different display forms in a state in which the external view of the entire system is preserved, and so the user can clearly recognize the usable image processing apparatus and the unusable image processing apparatus with display forms that are always familiar.

The present invention may be embodied in various other forms without departing from the gist or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

1. An image processing system configured from a plurality of processing units, the image processing system comprising:
a user interface that, along with displaying system information to an operator, receives an instruction from the operator, and
an interface control portion that controls the display of information in the user interface and the instruction from the operator, wherein
the interface control portion, when an external view of the entire image processing system configured from external views of the plurality of processing units is displayed via the user interface, even in the case where there is at least one unusable processing unit, also displays the external view of the unusable processing unit in a state in which the external view of the entire image processing system is preserved.

2. The image processing system according to claim 1, wherein the external view of the usable processing unit and the external view of the unusable processing unit have different display forms.

3. The image processing system according to claim 1, wherein
information related to the state of the usable processing unit, and an instruction receiving interface that receives an instruction given to the processing units from the operator, are displayed on the external view of the usable processing unit, and
information related to the state of the unusable processing unit is displayed on the external view of the unusable processing unit.

4. The image processing system according to claim 2, wherein also the display form of the instruction receiving interface related only to the unusable processing unit is changed in concert with the display form of the external view of the unusable processing unit.

5. The image processing system according to claim 1, wherein the unusable processing unit is in the midst of a recovery operation to a usable state.

6. The image processing system according to claim 5, wherein the unusable state of the unusable processing unit is any of a state in which there is a decrease in fixing temperature, a state in which there is a decrease in toner density, a state of inspection, a state of adjustment, or a state of warming up.

7. The image processing system according to claim 1, wherein the user interface is a touch panel.

8. The image processing system according to claim 3, wherein the instruction receiving interface is an operation key displayed with an icon.

9. The image processing system according to claim 2, wherein the unusable processing unit is in the midst of a recovery operation to a usable state.

10. The image processing system according to claim 3, wherein the unusable processing unit is in the midst of a recovery operation to a usable state.

11. The image processing system according to claim 4, wherein the unusable processing unit is in the midst of a recovery operation to a usable state.

12. The image processing system according to claim 2, wherein the user interface is a touch panel.

13. The image processing system according to claim 3, wherein the user interface is a touch panel.

14. The image processing system according to claim 4, wherein the user interface is a touch panel.

15. The image processing system according to claim 4, wherein the instruction receiving interface is an operation key displayed with an icon.
